(19) United States
(12) Patent Application Publication
(10) Pub. No.: US 2003/0037662 A1
(43) Pub. Date: Feb. 27, 2003

(54) Cymbal stand adjusting device

(76) Inventor: Wu-Hong Hsieh, Lu Chou City (TW)

Correspondence Address: Jones, Tullar & Cooper, P.C., Suite 1002, 2001 Jefferson Davis Highway, Arlington, VA, 22202, US

(21) Appl. No.: 09/932,991

(22) Filed: Aug. 21, 2001

(51) Int. Cl. G10D 13/02

(52) U.S. Cl. 84/422.3

(57) ABSTRACT

A securing device for a cymbal stand has a first clamping plate and a second clamping plate complimentarily corresponding to the first clamping plate. The first and second clamping plates are pivotally connected to each other at one end and are able to firmly engage with each other at the other end by a securing device such that the adjustment to the adjusting device allows the adjustment between the first and second clamping plates.

### BACKGROUND OF THE INVENTION

1. Field of the Invention

The present invention relates to an adjusting device, and more particularly to the adjusting device for a cymbal stand. The adjusting device is able to adjust the height of the stand and allows the supporting legs of the stand to have more room available.

2. Description of Related Art

With reference to FIG. 4, a conventional cymbal stand includes a first support tube (50) for supporting the cymbal (not numbered) and a supporting assembly (60). The supporting assembly (60) is slidably connected to the support tube (50) and has a base tube (62) receiving therein a part of the support tube (50), legs (61) one end of which is pivotally connected to the base tube (62) and the other end of which engages the ground and ribs (63) each pivotally connected between a corresponding one of the legs (61) and the base tube (62). With such an arrangement, the conventional stand is able to support the cymbal upright. However, when the stand is in use, the user has only little space left for maneuver. That is, when the pedal assembly (70), for example, is connected to the stand, the pedal assembly can only be changed within a limited space. When the conventional stand is connected in series with other instrumental assembly, the stand limits the manner of connection due to the little room available.

Further, the stand of this type can only provide height change of the support tube (50) to the base tube (62), the inclination of the legs (61) can not be changed, which further limits the adjustment of the stand.

To overcome the shortcomings, the present invention tends to provide an improved adjusting device for a cymbal stand to mitigate and obviate the aforementioned problems.

### SUMMARY OF THE INVENTION

The primary objective of the invention is to provide a cymbal stand adjusting device to allow the user to have more convenience and the cymbal stand to have more room for connection with other instrumental assembly.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the adjusting device of the present invention in connection with a cymbal stand;

FIG. 2 is an exploded perspective view of the adjusting device in accordance with the present invention;

FIG. 3 is an exploded perspective view of a first clamping plate of the adjusting device of FIG. 2; and

FIG. 4 is a perspective view of a conventional adjusting device for a cymbal stand.

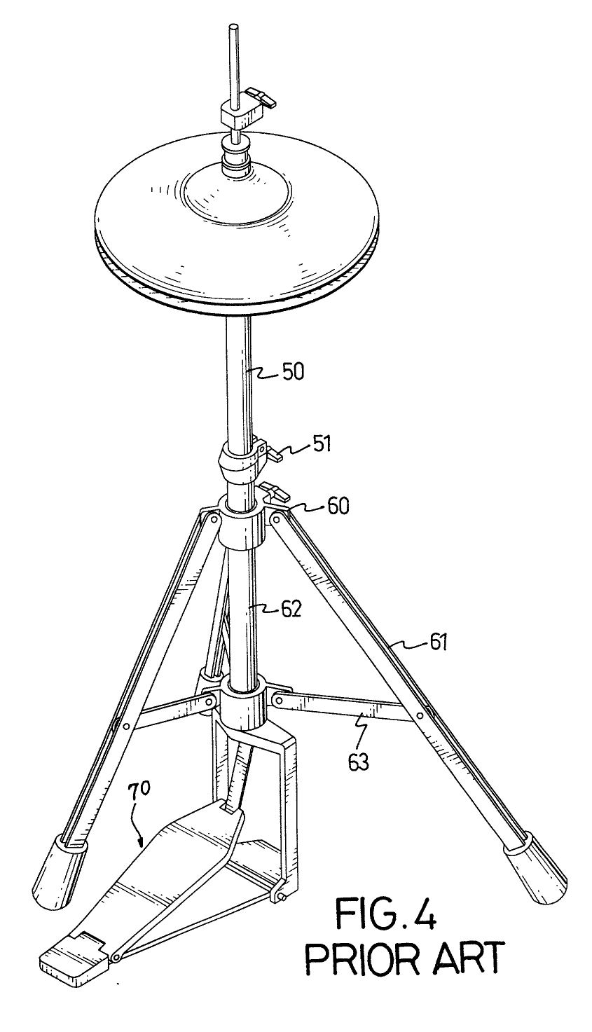

### DETAILED DESCRIPTION OF THE PREFERRED EMBODIMENT

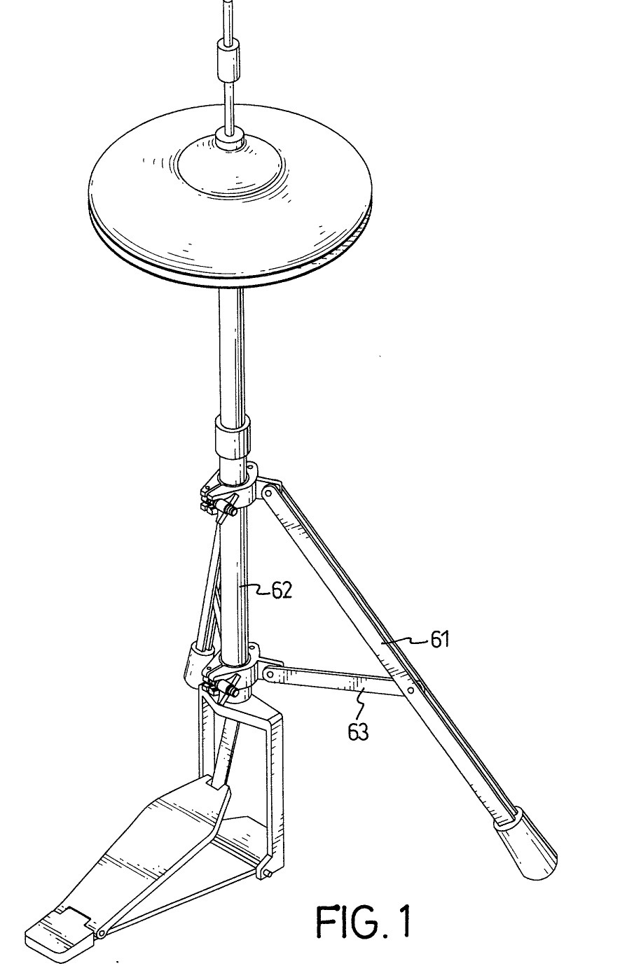

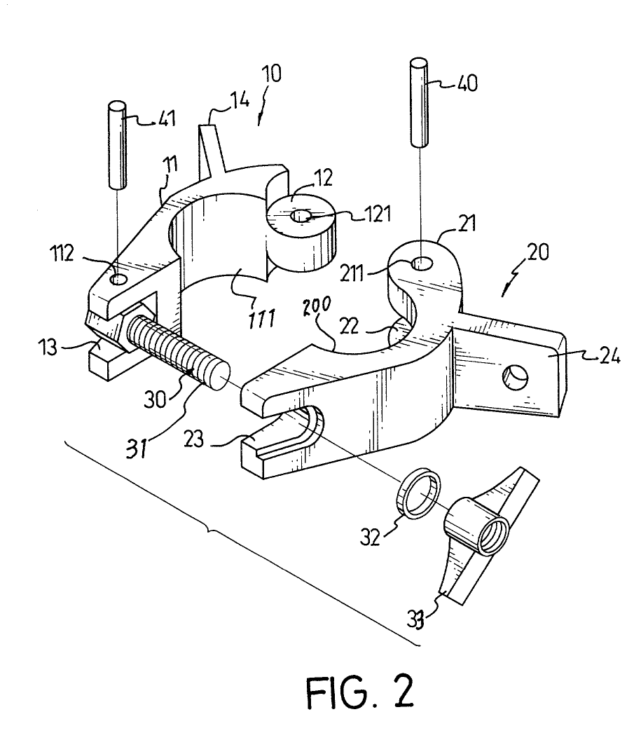

With reference to FIGS. 1 and 2, the adjusting device in accordance with the present invention is adapted to be mounted at the joint of the base tube (62) to the legs (61) and the joint of the base tube (62) to the ribs (63).

The adjusting device includes a first clamping plate (10) and a second clamping plate (20).

The first clamping plate (10) has a body (11) with a first arcuate recess (110), a disk (12) formed on one distal end of the body (11) and provided with a hole (121) centrally defined in the disk (12), a first fork (13) formed on the other distal end of the body (11) and a first connecting plate (14) formed on an outer face of the body (11). A positioning hole (112) is further defined in a top face of the fork (13) to allow a first positioning pin (41) to extend through the first positioning hole (112).

The second clamping plate (20) is pivotally connected to the first clamping plate (10) and has a second arcuate recess (200) complimentarily corresponding to the first arcuate recess (110), two ears (21) horizontally extending from one distal end of the second clamping plate (20) and each ear (21) having a through hole (211) aligned with each other and corresponding to the hole (121) of the disk (12), a gap (22) defined between the two ears (21) to correspond to the disk (12) and a cutout (23) defined in the other distal end of the second clamping plate (20) and having a shoulder (230) formed in a periphery defining the cutout (23).

A securing device (30) is provided to secure the engagement between the first and second clamping plates (10,20) and has a bolt (31) extending through the cutout (23) of the second clamping plate (20) and provided with a head (311) securely received in the first fork (13) of the first clamping plate (10), a washer (32) received in the shoulder (230) and a retainer (33) abutted to the washer (32) and screwed to the bolt (31).

When the adjusting device of the present invention is in use, the disk (12) is received in the gap (22) to allow the hole (121) to align the through holes (211) of the pair of ears (21). After the alignment between the through holes (211) and the hole (121), a second positioning pin (40) is able to extend into the aligned through holes (211) and hole (121) to secure the pivotal engagement between the first clamping plate (10) and the second clamping plate (20).

Thereafter, as previously described, because the adjusting device of the present invention is assembled at the joints of the base tube (62) to the legs (61) and of the base tube (62) to the ribs (63), the following description is taking the connection with the base tube (62) and the legs (61) for instance.

The first connecting plate (14) is pivotally connected to one leg (61) and the second connecting plate (24) is pivotally connected to the other leg (61) by means of any suitable method known in the art. Then, the base tube (62) is received in a room defined by the first and second arcuate recesses (110,200) of the first arcuate plate (10) and the second arcuate plate (20) respectively. Thereafter, the retainer (33) is screwed to the bolt (31) to secure the engagement of the first and second arcuate plates (10,20). After the first positioning pin (41) is inserted into the first positioning hole (112) to abut a face of the head (311) received in the fork (13), the engagement between the adjusting device to the base tube (62) together with the legs (61) is thus finished. Accordingly, the engagement between the base tube (62) and the ribs (63) is able to be finished in the same method. Thus, when adjustment of the relative position of the legs (61) to the base tube (62), the user only needs to unscrew the retainer (33) to allow the adjusting device of the present invention to slide on the outer periphery of the base tube (62). When a proper position is located, the user screws the retainer (33) to tighten the engagement of the adjusting device to the base tube (62) and an adjustment is finished.

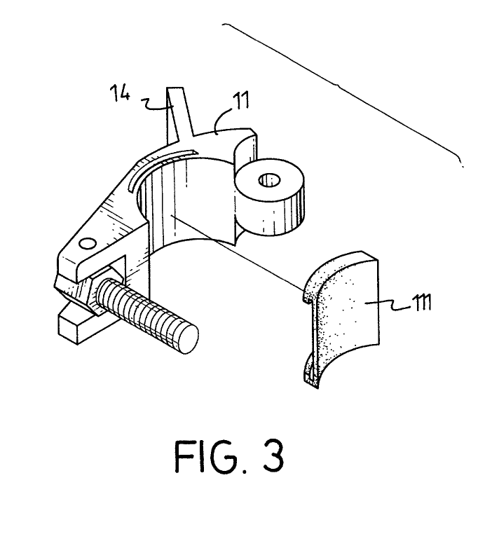

With reference to FIG. 3, to prevent the base tube (62) from sliding in the adjusting device, a rubber pad (111) is provided in the first arcuate recess (110) such that the rubber pad (111) is able to provide extra friction to the outer periphery of the base tube (62) after the base tube (62) is received in the adjusting device.

It is concluded that with the adjusting device of the present invention, the number of the legs is reduced so that the user will have more room available to make the necessary adjustment. Further, the adjustment to the relative position of the legs (61) to the base tube (62) can be easily accomplished.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An adjusting device for a cymbal stand having a base tube and legs, the adjusting device comprising:
a first clamping plate with a first arcuate recess, a disk formed on one end of the first clamping plate and provided with a hole defined through the disk, a fork formed on the other end of the first clamping plate and a first connecting plate formed on an outer periphery of the first clamping plate for pivotally connecting to one leg;
a second clamping plate with a second arcuate recess defined to complimentarily correspond to the first arcuate recess so as to hold the base tube therebetween, a pair of ears horizontally formed on one end of the second clamping plate to correspond to the disk and each ear having a through hole defined to align with the hole of the disk, a cutout defined in the other end of the second clamping plate to correspond to the fork and a second connecting plate formed on an outer periphery of the second clamping plate for pivotally connecting to the other leg;
a bolt extending through the cutout and provided with a head securely received in the fork; and
a retainer screwed to the bolt to secure the engagement between the first and second clamping plates so as to secure the holding to the base tube in the first and the second arcuate recesses.

2. The adjusting device as claimed in claim 1 further comprising a washer abutted a side face defining the cutout and the retainer.

3. The adjusting device as claimed in claim 2, wherein a shoulder is defined in the side face defining the cutout so that the washer is able to be securely mounted in the shoulder.

4. The adjusting device as claimed in claim 1, wherein the first arcuate recess further has a rubber pad securely received in the first arcuate recess to enhance holding of the base tube between the first and second arcuate recesses.
